(19) United States
(12) Patent Application Publication
(10) Pub. No.: US 2022/0108831 A1
(43) Pub. Date: Apr. 7, 2022

(54) SURFACE MOUNT INDUCTOR

(71) Applicant: TDK CORPORATION, Tokyo (JP)

(72) Inventors: Ryoei SHINOHARA, Tokyo (JP); Yoshihiro KOIKE, Tokyo (JP); Munehito NISHIMURA, Tokyo (JP)

(73) Assignee: TDK CORPORATION, Tokyo (JP)

(21) Appl. No.: 17/462,902

(22) Filed: Aug. 31, 2021

(30) Foreign Application Priority Data
Oct. 2, 2020 (JP) 2020-167519

(51) Int. Cl. H01F 27/28; H01F 27/29; H01F 27/24

(52) U.S. Cl. CPC H01F 27/2823; H01F 27/24; H01F 27/29

(57) ABSTRACT

A surface mount inductor including: a core comprising a winding core and a pair of flanges connected to both sides of the winding core; a pair of electrodes formed on at least a part of the outer peripheral surfaces of the pair of flanges; and a wire wound around the winding core in which a pair of wire ends are fixed to the pair of electrodes. In the surface mount inductor, the wire includes a first part wound in contact with an adjacent turn and a second part wound away from an adjacent turn and is connected to the wire end, and a gap between the first part and the second part, as viewed from a mounting surface side where the wire end is fixed to the electrode, is 0.5 to 3 times a pitch of the first part.

### BACKGROUND OF THE INVENTION

### 1. Field of the Invention

The invention relates to a surface mount inductor.

### 2. Description of the Related Art

Surface mount inductors are required to be miniaturized and have an increased inductance value. To reduce the size and increase the inductance value of the surface mount inductors, it is conceivable to wind a wire tightly around the core and increase the number of turns (See Patent Document 1 and the others).

There was a problem in the conventional surface mount inductor, however, that a joint part for fixing the wire to the electrode becomes too close to the winding part of the wire when the number of wire turns is increased in a small core. Thus, the thermal effect from the joint part is transmitted to the winding part of the wire if the distance between the winding part and the joint part is insufficient, and the problems such as exposing a conducting wire from an insulating coating of the wire, or arising a short circuit may occur.

[Patent Document 1] Japanese Unexamined Patent Application H10-321438

### SUMMARY OF THE INVENTION

The invention has been made in consideration of such situation, and provides a surface mount inductor that are compact in size but can prevent transmitting a thermal effect from a wire end to a winding wire.

To achieve the object, a surface mount inductor of the invention includes:

a surface mount inductor including:

a core including a winding core and a pair of flanges connected to both sides of the winding core;

a pair of electrodes formed on at least a part of the outer peripheral surfaces of the pair of flanges; and

a wire wound around the winding core wherein a pair of wire ends are fixed to the pair of electrodes, wherein

the wire comprises a first part wound in contact with an adjacent turn and a second part wound away from an adjacent turn and is connected to the wire end, and

a gap between the first part and the second part, as viewed from a mounting surface side where the wire end is fixed to the electrode, is 0.5 to 3 times a pitch of the first part.

The surface mount inductor according to the invention includes the first part, where the wire is wound in contact with an adjacent turn, and a second part, where the wire is wound apart from an adjacent turn and connected to the end of the wire. Such surface mount inductor has the first part to secure the number of wire turns in a small core, and has the second part to prevent transmitting the thermal effect from the wire end to the winding wire. By making the gap between the first part and the second part viewed from the mounting surface side to 0.5 to 3 times the pitch of the first part, the number of wire turns is secured and it is possible to prevent transmitting the thermal effect from the wire end to the winding wire.

For instance, the surface mount inductor may include one first part and two second parts, and the first part may directly connect the two second parts.

Such surface mount inductor can effectively prevent transmitting thermal effect from both wire ends to the winding part, and also can effectively secure the number of wire turns by making one first part to directly connect two second parts.

For instance, the number of wire turns of at least one of the second parts is less than one turn.

By setting the number of turns of the second part to less than one turn, the first part which can efficiently increase the number of wire turns can be increased. Thus, such surface mount inductor can be miniaturized.

For instance, a lower side of the first part, contacting the winding core on the mounting surface side, may be wound with respect to a virtual plane orthogonal to an axial direction of the winding core at an inclination of 1.5 to 3 pitches relative to the pitch of the first part.

At the first part where the wires are wound in close contact with each other, the position of the wire moves in the axial direction by one pitch in one turn (one pitch is equal to a diameter of the wire). Thus, if the wires are evenly inclined at the winding core, each part of the first part wound around the winding core having a rectangular cross section is diagonally wound at an inclination of approximately ¼ pitch with respect to the virtual plane. By increasing the inclination at the lower side of the first part on the mounting surface side and winding diagonally by 1.5 to 3 pitches, however, the gap between the first part and the second part as seen from the mounting surface side can be increased.

For instance, an upper side of the first part, contacting the winding core on a side opposite to the mounting surface side, may be wound diagonally with respect to the virtual plane at an inclination smaller than the lower side of the first part.

By making the inclination of the lower side of the first part and the same of the upper side of the first part to have such relationship, it is possible to make an appropriate shape of the gap between the first part and the second part, secure the number of wire turns, and prevent transmission of the thermal effects.

For instance, a side of the first part, connecting the upper side of the first part contacting the winding core on the side opposite to the mounting surface side and the lower side of the first part, may be wound in parallel to the virtual plane.

By making the winding form of the lower side of the first part and the same of the side of the first part as described above, it is possible to make an appropriate shape of the gap between the first part and the second part, secure the number of wire turns, and prevent transmission of the thermal effects.

For instance, the side of the first part, connecting the upper side of the first part contacting the winding core on the side opposite to the mounting surface side and the lower side of the first part, may be wound with respect to the virtual plane at an inclination smaller than on the lower side of the first part

The side of the first part may be parallel to the virtual plane, but may be wound diagonally with respect to the virtual plane at an inclination smaller than that of the upper side of the first part. Even with the form described above, it is possible to effectively prevent transmission of thermal effects while ensuring the number of wire turns.

For instance, a contact of the second part, contacting the winding core, may be in parallel to a virtual plane orthogonal to an axial direction of the winding core.

In such surface mount inductor, the shape of the gap between the first part and the second part can be appropriately formed while making a narrow second part.

For instance, the second part may be distant from a lower edge of the mounting surface side at an edge of the winding core.

Since the contact of the second part is distant from the lower edge, it is possible to prevent the problem that the part close to the wire end and susceptible to heat is pressed against the edge of the winding core and is damaged.

### BRIEF DESCRIPTION OF THE DRAWINGS

FIG. 1 is a front view of a surface mount inductor according to a first embodiment of the invention.

FIG. 2 is a rear view of the surface mount inductor shown in FIG. 1.

FIG. 3 is a left side view of the surface mount inductor shown in FIG. 1.

FIG. 4 is a right side view of the surface mount inductor shown in FIG. 1.

FIG. 5 is a top view of the surface mount inductor shown in FIG. 1.

FIG. 6 is a bottom view of the surface mount inductor shown in FIG. 1.

FIG. 7 is a top view of the surface mount inductor shown in FIG. 1, in which the plate core is removed.

FIG. 8 is a perspective view of the surface mount inductor shown in FIG. 1, in which the plate core is removed.

FIG. 9 is a cross-sectional view of the surface mount inductor shown in FIG. 1, in which the plate core is removed.

FIG. 10 is an enlarged view of a periphery of the mounting surface side edge of the surface mount inductor shown in FIG. 1.

FIG. 11 is a conceptual diagram comparing a winding shape of the upper side and the same of the lower side in the surface mount inductor shown in FIG. 1.

FIG. 12 is a front view of a surface mount inductor according to a second embodiment of the invention.

FIG. 13 is a rear view of the surface mount inductor shown in FIG. 12.

FIG. 14 is a left side view of the surface mount inductor shown in FIG. 12.

FIG. 15 is a right side view of the surface mount inductor shown in FIG. 12.

FIG. 16 is a top view of the surface mount inductor shown in FIG. 12.

FIG. 17 is a bottom view of the surface mount inductor shown in FIG. 12.

FIG. 18 is a front view of a surface mount inductor according to a third embodiment of the invention.

### DESCRIPTION OF THE EMBODIMENTS

Hereinafter, the invention will be described based on the embodiments shown in the drawings.

### First Embodiment

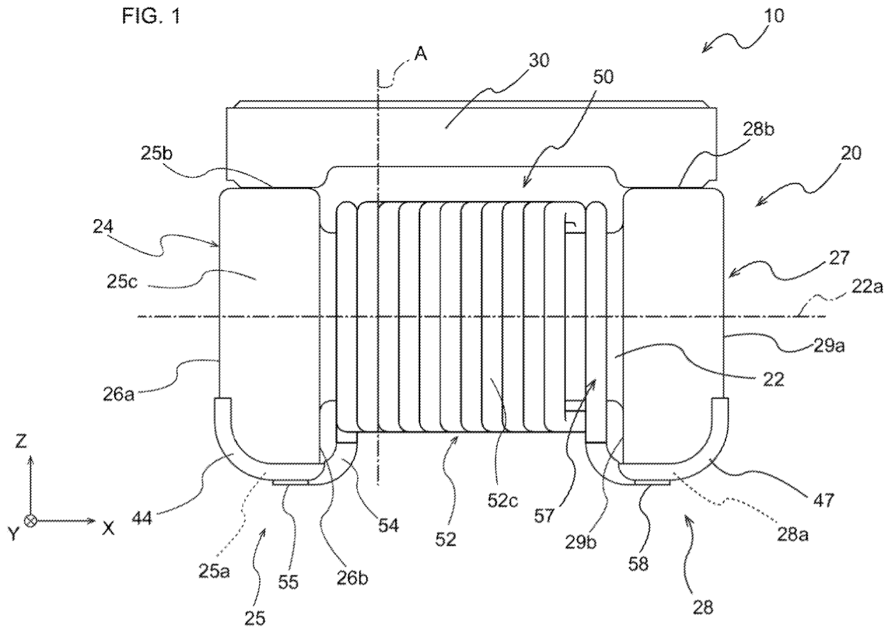

FIG. 1 is a front view of a surface mount inductor 10 (hereinafter, simply referred to as “inductor 10”) according to a first embodiment of the invention. The inductor 10 has a core 20 which is a drum core, a plate core 30, electrodes 44 and 47, and a wire 50. The inductor 10 has a substantially rectangular parallelepiped outer shape, and for example, the inductor 10 is surface-mounted on a mounting substrate by sucking and holding the upper surface of the plate core 30 by a suction nozzle of a mounting machine and transporting thereof. The inductor 10 is not limited to the one having the plate core 30, however, and the inductor 10 may be the one in which the suction nozzle is sucked to another part of the inductor 10.

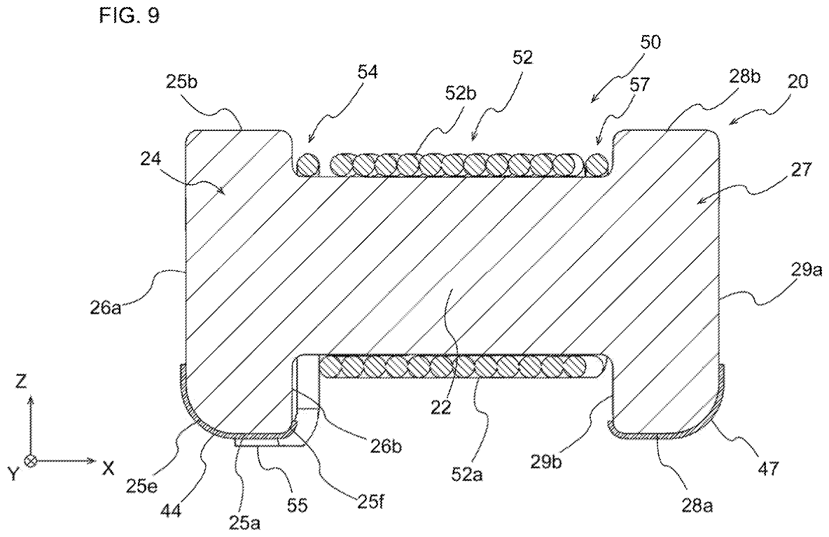

The core 20 and the plate core 30 are joined to each other by an adhesive such as an epoxy adhesive. FIG. 9 is a cross-sectional view of a part of the inductor 10 shown in FIG. 1 excluding the plate core 30. As shown in FIG. 9, the core 20 has a winding core 22 and a pair of flanges 24, 27 connected to both sides of the winding core 22.

The wire diameter of the conductive wire rod constituting the lead terminal 8 is appropriately determined according to the size of the ceramic element body 4. For example, the wire diameter can be 0.5 mm to 1.0 mm, preferably 0.5 mm to 0.6 mm.

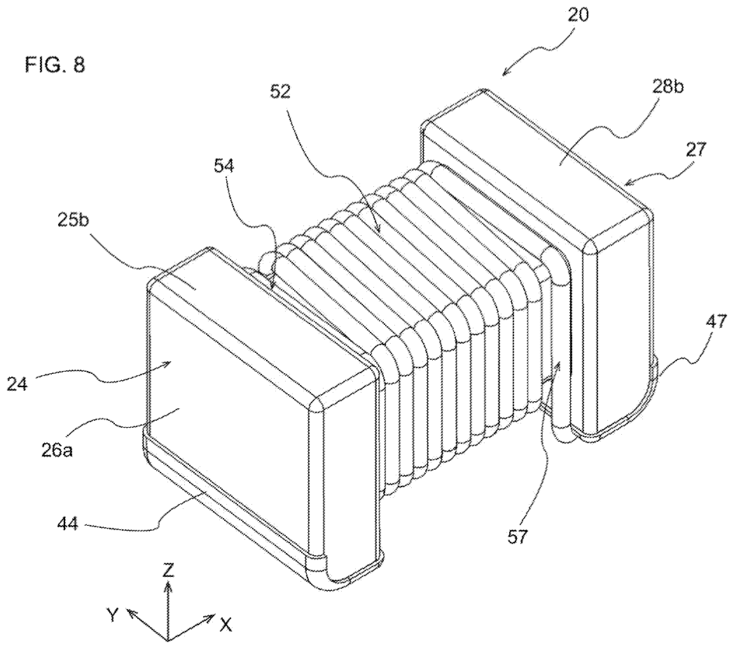

As can be understood from FIG. 8 which is a perspective view of the inductor 10 excluding the plate core 30, the core 20 and the flanges 24, 27 have a substantially rectangular parallelepiped shape. That is, the winding core 22 has a substantially square columnar shape, and the cross-sectional shape of the winding core 22 orthogonal to the axial direction 22a (See FIG. 1) is substantially rectangular. The shape of the winding core 22 is not limited to this, however, and may be a columnar shape, a polygonal columnar shape, or the like.

In the description of the inductor 10, the X-axis direction is the axial direction of the winding core 22, the Z-axis direction is the normal directions of the flanges 25b, 28b of the flanges 24, 27 to which the plate core 30 is joined, and the Y-axis direction is orthogonal to both the X-axis direction and the Z-axis direction.

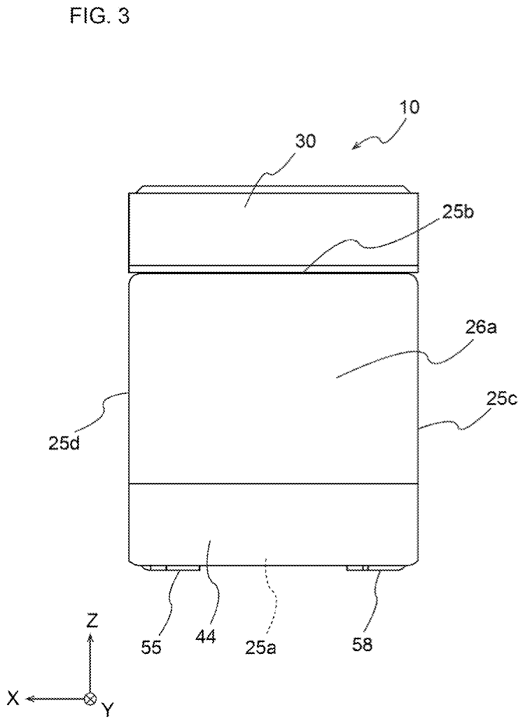

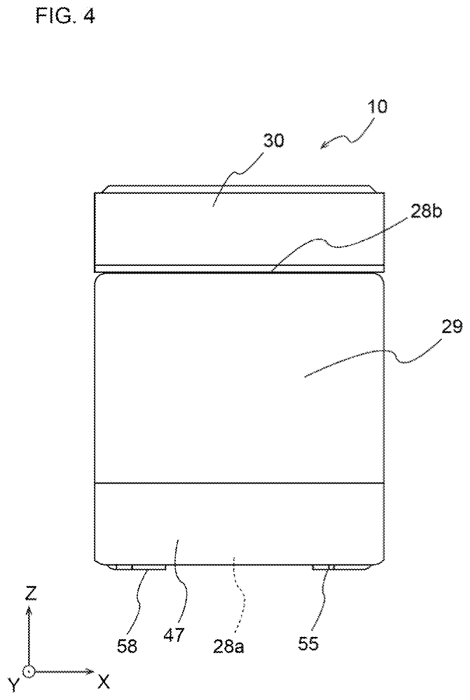

As shown in FIG. 1, one end of the winding core 22 is connected to the inner side surface 26b of the flange, which is the surface of the flange 24 on the positive direction side of the X axis; the other end of the winding core 22 is connected to the inner side surface 29b of the flange, which is a side surface of the flange 27 on the negative direction side of the X axis. As shown in FIG. 3 of a left side view, the end surface 26a, which is the surface of the flange 24 on the negative direction side of the X axis, constitutes the end surface of the core 20. Further, as shown in FIG. 4 of a right side view, the end surface 29a, which is the surface of the flange 27 on the positive direction side of the X-axis, constitutes the end surface of the core 20.

As shown in FIG. 8, a pair of electrodes 44, 47 are formed on at least a part of the outer peripheral surfaces 25, 28 on the pair of flanges 24, 27. The electrode 44 is formed to cover the lower surface 25a of the flange facing the negative direction side of the Z axis of the outer peripheral surface 25 extending substantially parallel to the axial direction of the winding core 22 in the flange 24. The plate core 30 (see FIG. 1) is fixed to the outer peripheral surface 25, which is the upper surface 25b of the flange facing the Z-axis positive direction side in the direction opposite to the lower surface 25a of the flange 24.

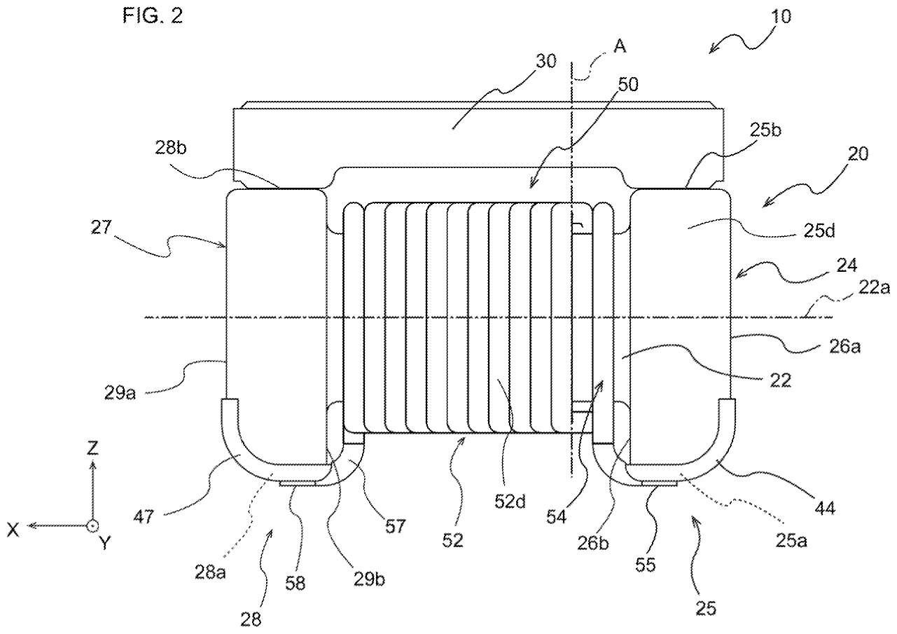

The electrode 44 may be formed to cover not only the lower surface 25a of the flange, but also the side surfaces 25c and 25d (see FIGS. 1 and 2) of the flange, which are the outer peripheral surfaces 25 other than the lower surface 25a of the flange 24, and a part of the end surface 26a. Provided that the electrode 44 is not formed on the upper surface 25b of the flange to which the plate core 30 is joined.

As shown in FIG. 1, each edge of the flange 24 is R-processed. As shown in FIG. 9, the lower outer edge 25e, connecting the lower surface 25a of the flange on which the electrode 44 is formed and the end surface 26a, is subjected to R processing different from other parts. That is, the R processing radius of the lower outer edge 25e is larger than the same of the lower inner edge 25f that connects the lower surface 25a of the flange and the inner side surface 26b of the flange. Such lower outer edge 25e can form a solder fillet having an appropriate shape between the electrode 44 and the land pattern, even when the inductor 10 is mounted on a land pattern narrower than the conventional one.

As shown in FIG. 9, the electrode 47 is formed to cover the lower surface 28a of the flange 27. Since the electrode 47 and the flange 27 have shapes substantially symmetrical to those of the electrode 44 and the flange 24, description of the detailed shapes will be omitted.

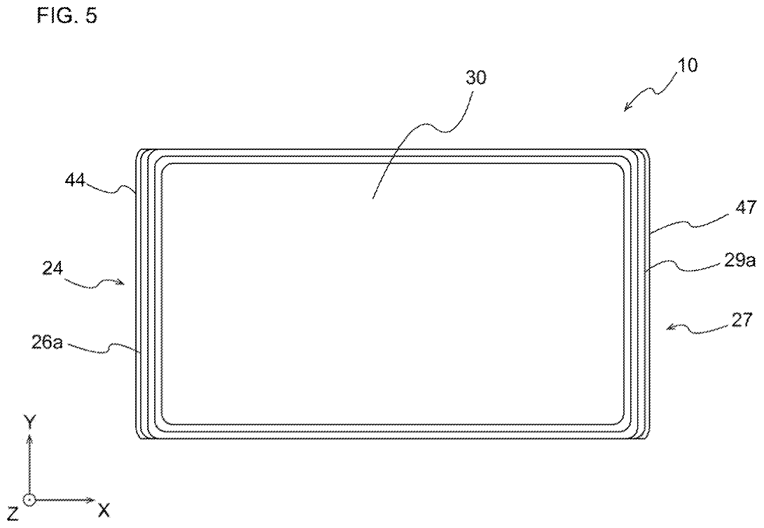

FIG. 5 is a top view of the inductor 10. As shown in FIGS. 1 and 5, the plate core 30 has a substantially flat outer shape, and in the core 20, the upper surface 25b of one flange 24 is connected to the upper surface 28b of the other flange 27

The core 20 and the plate core 30 shown in FIG. 1 are manufactured by such as a magnetic material. The core 20 and the plate core 30 may be manufactured by the same kind of material, or may be by different materials. The material of the core 20 and the plate core 30 may be, for example, a metal such as pure iron, Fe—Ni alloy, Fe—Si alloy, Fe—Si—Al alloy, or Fe—Si—Cr alloy. The material of the core 20 and the plate core 30 may be, for example, a ferrite such as a Mn—Zn-based ferrite or a Ni—Zn-based ferrite.

The electrodes 44, 47 shown in FIG. 9 and the like are manufactured through such as forming a film by applying, baking or plating an electrode material such as Ag, Ni, Sn to the flanges 24, 27. The electrodes 44 and 47 are not limited to these, however, and for example, a metal plate may be attached to the flanges 24, 27 to manufacture the electrodes 44 and 47.

As shown in FIG. 1, a part of the wire 50 is wound around the winding core 22 of the core 20. The wire 50 has a first part 52 and second parts 54, 57 wound around the winding core 22, and a pair of wire ends 55, 58 fixed to a pair of electrodes 44, 47.

The wire 50 is a coated conducting wire or the like, and the conducting wire may be a single wire or a stranded wire. The wire ends 55, 58 is fixed to the electrodes 44, 47 by such as welding, soldering, and thermocompression bonding.

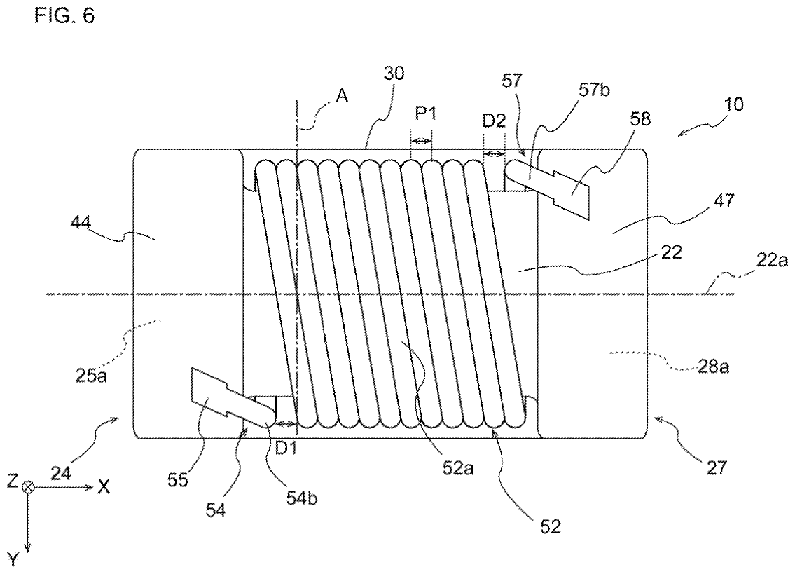

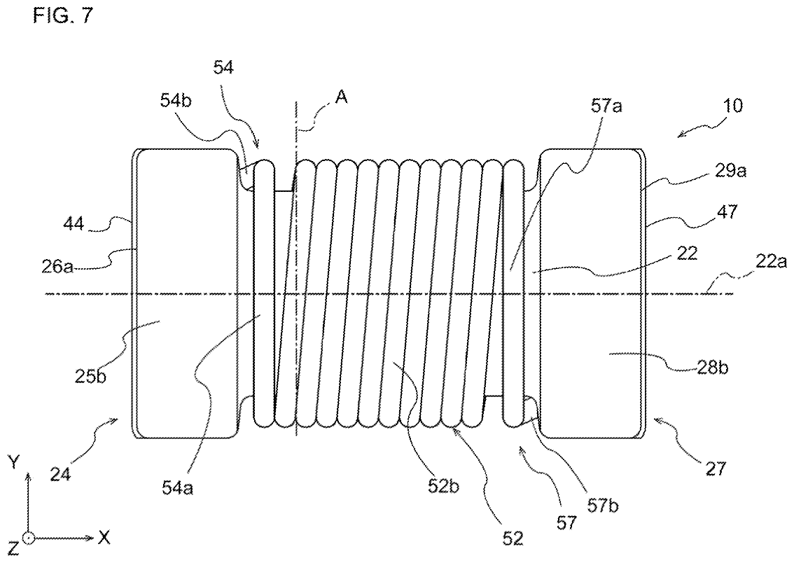

FIG. 2 is a rear view of the inductor 10, and FIG. 6 is a bottom view of the inductor 10. Further, FIG. 7 is a top view of the inductor 10 excluding the plate core 30. As shown in FIGS. 1, 2, 6 and 7, the wire 50 has the first part 52, which is wound in contact with the adjacent turn, the second part 54, which is wound apart from the adjacent turn and connects to the wire end 55, and the second part 57, which is wound apart from the adjacent turn and connects to the wire end 58.

The wire 50 has one first part 52 and two second parts 54, 57. The first part 52 directly connects the two second parts 54, 57. In the wire 50, the number of turns of the first part 52 that is tightly wound in contact with the adjacent turn is preferably more than the sum of the number of turns of the two second parts 54, 57 that are wound apart from the adjacent turn.

The number of turns of at least one of the second parts 54, 57 is preferably less than one turn, and more preferably, the number of turns of both second parts 54, 57 are less than one turn. By reducing the number of turns of the second parts 54, 57, it is possible to secure a wide area for the first part 52, increase the number of turns of the first part 52, and reduce the size of the inductor 10. The number of turns of the second parts 54, 57 in the inductor 10 is approximately ½ turn, but the number of turns of the second parts 54, 57 is not limited thereto.

As shown in FIG. 6, the gap D1 between the first part 52 and the second part 54 as viewed from the mounting surface side (the Z-axis negative direction side), in which the wire end 55 is fixed to the electrode 44, is preferably 0.5 to 3 times, more preferably 0.8 to 2.5 times, and further preferably 1 to 1.5 times the pitch P1.

By setting the gap D1 between the first part 52 and the second part 54 to a predetermined magnification or more of the pitch P1 of the first part 52, transferring heat to the first part 52 when fixing the wire end part 55 can be prevented. Thus, melting of the insulating coating of the first part 52 or peeling off the insulating coating of the first part 52 due to an explosion of the conducting wire of the wire 50 can be prevented. Further, by setting the gap D1 between the first part 52 and the second part 54 to a predetermined magnification or more of the pitch P1 of the first part 52, it is possible to prevent the winding core 22 from becoming too long, and contribute to the miniaturization of the inductor 10. In the first part 52, since the wire 50 is tightly wound in contact with the adjacent turn, the pitch P1 of the first part 52 is substantially equal to the wire diameter (diameter) of the wire 50.

As shown in FIG. 6, the gap D2 between the first part 52 and the second part 57 as viewed from the mounting surface side (the Z-axis negative direction side), in which the wire end 58 is fixed to the electrode 47, for the same reason as the gap D1, is preferably 0.5 to 3 times, more preferably 0.8 to 2.5 times, and further preferably 1 to 1.5 times of the pitch P1.

Further, as shown in FIG. 6, at lower side 52a of the first part 52 contacting the winding core 22 on the mounting surface side (the Z-axis negative direction side) is preferably diagonally wound at an inclination of 1.5 to 3 pitches based on the pitch P1 of the first part 52 with respect to the virtual plane (the Y-Z plane) orthogonal to the (the X-axis direction) axial direction of the winding core 22. Further, the inclination direction of the lower side 52a of the first part is such that the lower side 52a of the first part on the side (the Y-axis positive direction side) closer to the wire end 55 is preferably oriented away from the flange 24 to which the wire end 55 is fixed, as compared with the lower side 52a (the Y-axis negative direction side) of the first part on the side away from the wire end 55.

Here, at the first part 52 in which the wire 50 is wound in close contact, the position of the wire 50 moves in the axial direction (the X-axis direction) by one pitch P1 in one turn. Therefore, to evenly incline the wire 50 at the winding core 22, the wire 50 is wound at an inclination of ¼ pitch with respect to the virtual plane A at each part of the lower part, the upper part, and the side part of the first part 52. As shown in FIG. 6, however, by increasing the inclination of the lower side 52a of the first part at the mounting surface side and winding the wire 50 diagonally with respect to the virtual plane A at an inclination of 1.5 pitch or more, the gap D1 between the first part 52 and the second part 54 as seen from the mounting surface side can be made longer within the limited length of the winding core 22. Further, on the flange side 27, the wire end 58 is fixed to the electrode 47 to have rotational symmetry of approximately 180 degrees with respect to the wire end 55. Thus, the gap D2 between the first part 52 and the second part 54 can be made longer as similar to the gap D1.

Further, by winding the lower side 52a of the first part diagonally with respect to the virtual plane A at an inclination of three pitches or less, it is possible to prevent the problem that the length of the gaps D1 and D2 become too long more than necessary and the length of the winding core 22 become long. The lower side 52a of the first part shown in FIG. 6 is wound diagonally at an inclination of two pitches with respect to the virtual plane A, but the inclination of the lower side 52a of the first part with respect to the virtual plane A is not limited thereto.

Further, as shown in FIG. 7, the upper side 52b of the first part contacting the winding core 22 on the side (the Z-axis positive direction side) opposite to the mounting surface side, with respect to the virtual plane A, is preferably wound diagonally with an inclination smaller than that of the lower side 52a of the first part. As a result, the gaps D1 and D2 shown in FIG. 6 can be appropriately formed on the mounting surface side while forming the first part 52, which is in contact with the adjacent turn.

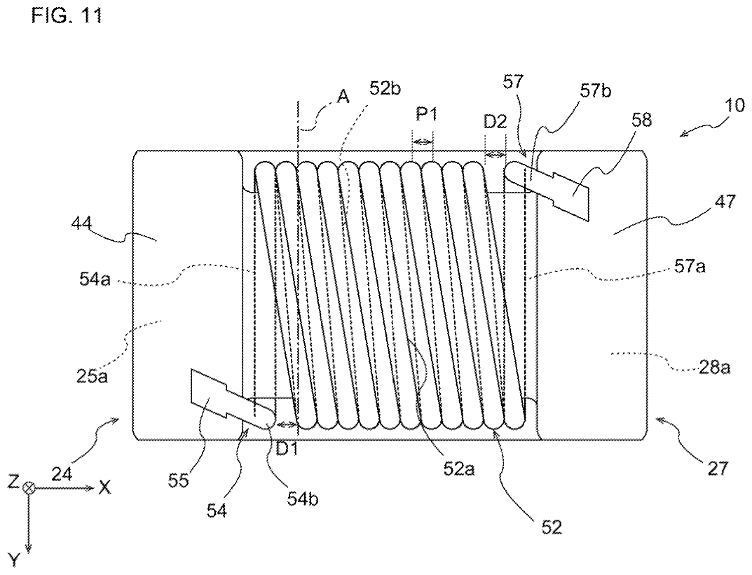

FIG. 11 is a conceptual diagram in which the winding core 22 is seen through, and the upper side 52b (the dotted line in FIG. 11) of the first part is superimposed on the lower side 52a of the first part shown in FIG. 9. As shown in FIG. 11, the lower side 52a of the first part is wound diagonally at an inclination of two pitches with respect to the virtual plane A, whereas the upper side 52b of the first part is wound diagonally at an inclination of one pitch with respect to the virtual plane A. By inclining the lower side 52a of the first part on the mounting surface side more than the upper side 52b of the first part with respect to the virtual plane A, the gaps D1 and D2 having predetermined lengths can be formed on the winding core 22 of shorter length.

As shown in FIGS. 1 and 2, according to the first part 52, the sides 52c, 52d of the first part that connect the upper side 52b of the first part on the plate core 30 side and the lower side 52a of the first part on the mounting surface side are parallel to the virtual plane A (the Y-Z plane) orthogonal to the axial direction of the winding core 22. As a result, the length of the gap (see FIG. 1) between the side 52c of the first part and the second part 57 and the length of the gap (see FIG. 2) between the side 52d of the first part and the second part 54 can be the same as the length of the gaps D1 and D2 formed on the mounting surface side, which is preferable from the viewpoint of preventing thermal damage to the insulating coating at the first part 52. Sides 52c and 52d of the first part and the upper side 52b of the first part may be different from the modes shown in the first embodiment. For example, the sides 52c and 52d of the first part may be inclined with respect to the virtual plane A, and the upper side 52b of the first part may be parallel to the virtual plane A.

As shown in FIG. 7, the second parts 54 and 57 of the wire 50 respectively include contacts 54a and 57a of the second part, which contact the winding core 22. Further, as shown in FIG. 6, the second parts 54 and 57 respectively include lead-outs 54b and 57b of the second part that are distant from the winding core 22. The contacts 54a and 57a of the second part shown in FIG. 7 are respectively connected to the first part 52, and the lead-outs 54b and 57b of the second part shown in FIG. 6 are connected to the wire ends 55 and 58.

As shown in FIG. 7, contacts 54a and 57a of the second part respectively included in the second parts 54 and 57 are preferably parallel to the virtual plane A (the Y-Z plane) orthogonal to the axial direction of the winding core 22. As a result, gaps D1 and D2 having predetermined lengths can be formed on the winding core 22 of shorter length.

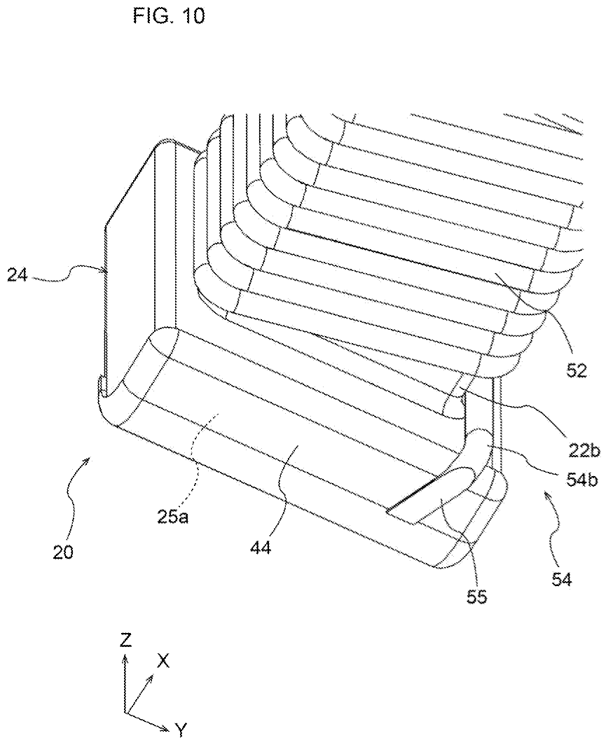

FIG. 10 is a partially enlarged view of the inductor 10 excluding the plate core 30 in which the peripheral part of the lead-out 54b of the second part of the wire 50 is enlarged. As shown in FIG. 10, the second part 54 of the wire 50 is distant from the lower edge 22b on the mounting surface side (the Z-axis negative direction side), which is the edge of the winding core 22, and is distant from the lower edge 22b. In other words, the second part 54 contacts the surface of the winding core 22 on the positive direction side of the Z-axis, forms the contact 54a of the second part (see FIG. 7), and then becomes the lead-out 54b of the second part distant from the winding core 22 before it reaches the lower edge 22b on the mounting surface side (see FIG. 10).

As shown in FIG. 10, since the second part 54 of the wire 50 is distant from the lower edge 22b of the winding core 22, the insulating coating of the wire 50 is prevented from damaging by the thermal influence of the wire end 55 and the insulation between the wire 50 and the core 20 can be reliably ensured. If the wire 50 is in contact with the lower edge 22b, the contact part with the edge of the core 20 is arranged near the wire end 55, so that the insulating coating of the wire 50 at the contact part is easily damaged. As shown in FIG. 10, however, the above problems can be avoided by distancing the second part 54 from the lower edge 22b of the winding core 22.

Similar to the second part 54, the second part 57 of the wire 50 is also distant from the lower edge on the mounting surface side (the Z-axis negative direction side) of the winding core 22, and does not contact the lower edge. Thus, the inductor 10 can suitably prevent the problem that the insulating coating is damaged by the thermal influence from the wire ends 55 and 58 at the contact part between the core 20 and the wire 50.

As described above, the inductor 10 according to the first embodiment, problems such as a short circuit at the contact part of the wire 50 can be prevented (see FIG. 6 and the like) by making the gaps D1 and D2 between the first part 52 and the second parts 54 and 57 as viewed from the mounting surface side (the Z-axis negative direction side) to a predetermined length. Further, by inclining the lower side 52a of the first part with respect to the virtual plane A within a predetermined range, the gaps D1 and D2 are efficiently formed in the limited length of the winding core 22, which is advantageous from the viewpoint of miniaturization.

### Second Embodiment

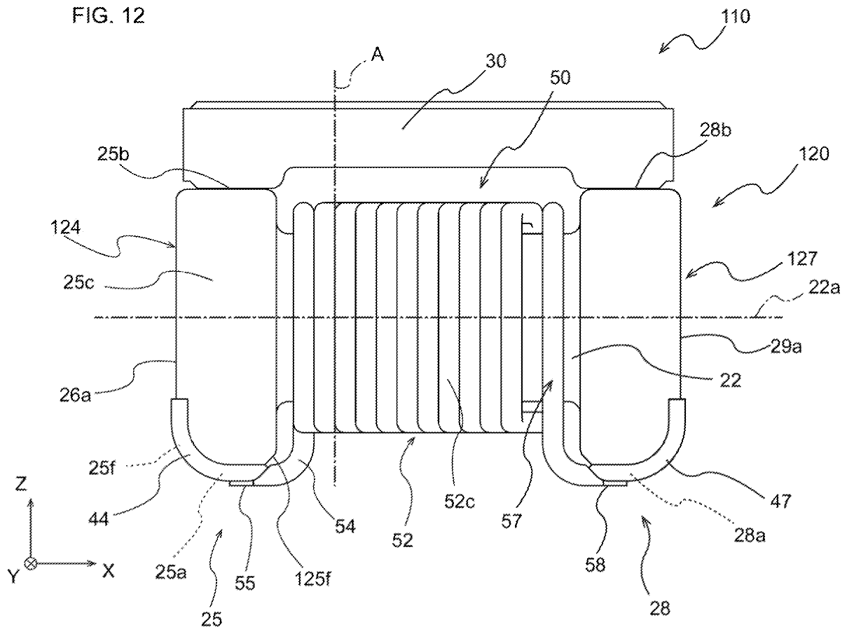

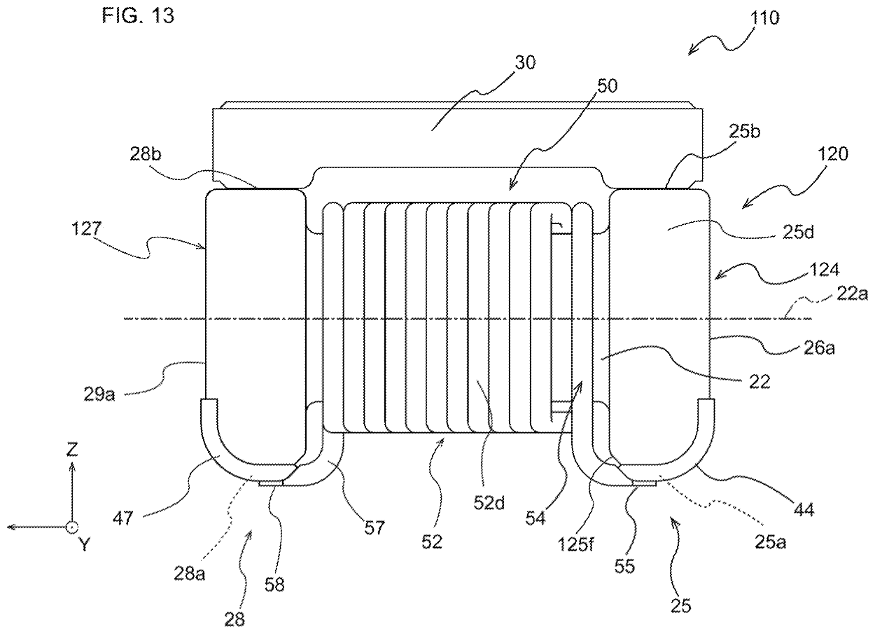

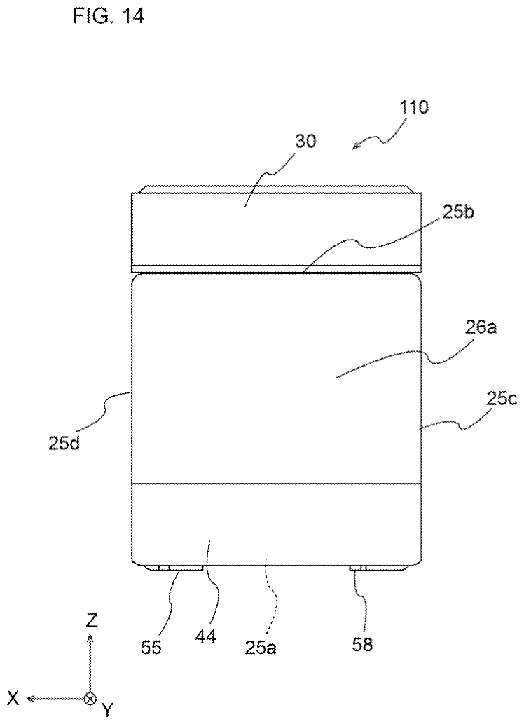

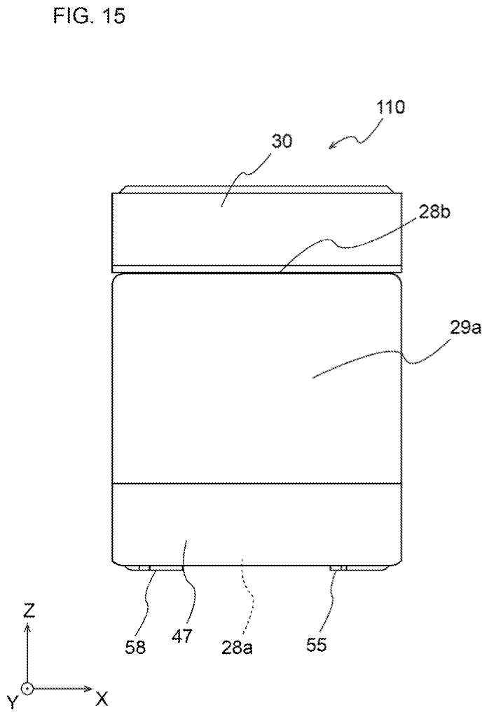

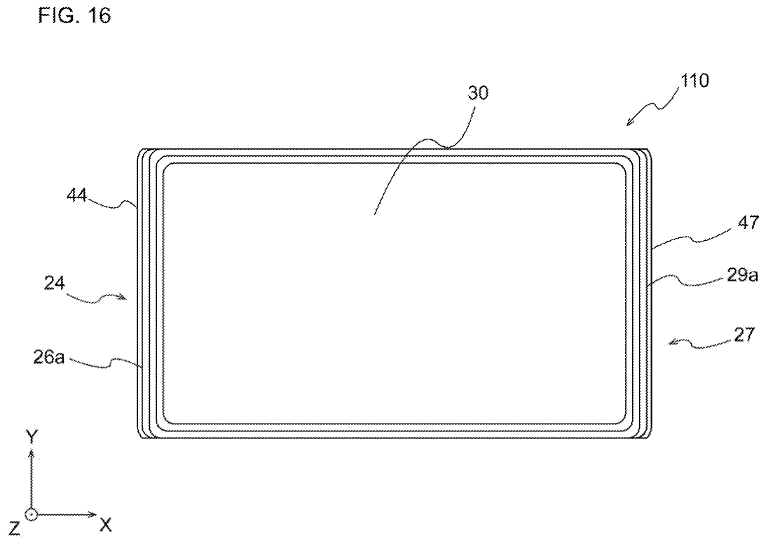

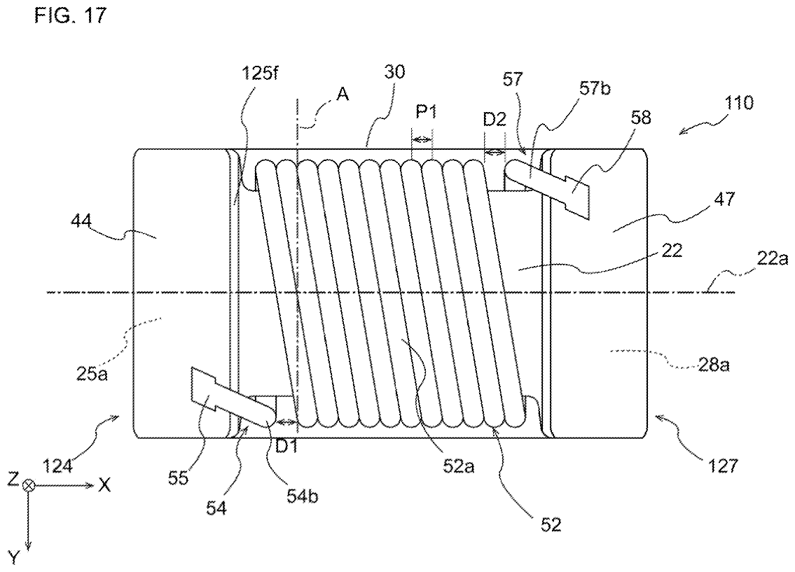

FIGS. 12 to 17 respectively show a front view, a rear view, a left side view, a right side view, a top view, and a bottom view of the inductor 110 according to the second embodiment of the invention. The inductor 110 according to the second embodiment is the same as the inductor 10 according to the first embodiment except that the shape of the lower inner edge 125f of the flanges 124 and 127 in the core 120 is different. Regarding the inductor 110 of the second embodiment, only the differences from the inductor 10 will be described, and the common points with the inductor 10 will be omitted.

As shown in FIG. 12, the lower inner edge 125f of the flange 124 is chamfered (C surface). Like the inductor 110, the lower inner edge 125f of the flange 24 may be chamfered instead of R-processed. In this case, the R processing radius of the lower outer edge 25e is preferably larger than the chamfered size of the lower inner edge 125f. The flange 127 has a shape substantially symmetrical to that of the flange 124. As described above, each edge of the core 20 may be subjected to R processing or chamfer processing.

The inductor 110 according to the second embodiment also show the similar effect as the inductor 10 according to the first embodiment.

### Third Embodiment

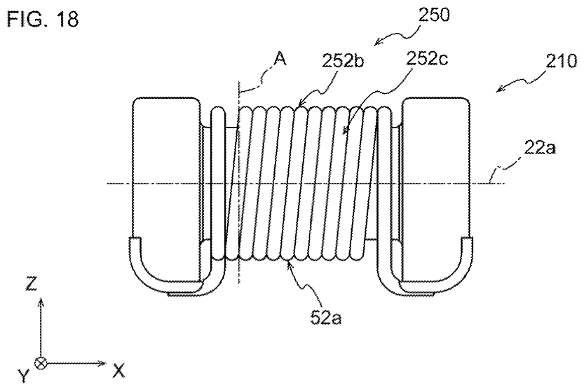

FIG. 18 is a front view of the inductor 210 according to the third embodiment of the invention, which exclude the flat plate. The inductor 210 according to the second embodiment is the same as the inductor 10 according to the first embodiment, except the side 252c of the first part is inclined with respect to the virtual plane A orthogonal to the axial direction of the winding core 22, and the upper side 252b of the first part is parallel to the virtual plane A. Regarding the inductor 210 of the third embodiment, only the differences from the inductor 10 will be described, and the common points with the inductor 10 will be omitted.

As shown in FIG. 18, in the inductor 210, the side 252c of the first part, connecting the upper side 252b of the first part and the lower side 52a of the first part, is wound diagonally with respect to the virtual plane A with an inclination smaller than the same of the lower side 52a of the first part. The side 252c of the first part in the inductor 210 is wound diagonally at an inclination of one pitch P1 with respect to the virtual plane A. Although not shown in FIG. 18, the upper side 252b of the first part and the side 52d of the first part are both parallel to the virtual plane A. The lower side 52a of the first part in the inductor 210 is wound diagonally at an inclination of twice the one pitch P1 with respect to the virtual plane A, similar to the inductor 10 according to the first embodiment (see FIG. 6).

In the inductor 210, the upper side 252b of the first part is wound parallel to the virtual plane A, and the side 252c of the first part is diagonally wound with respect to the virtual plane A. In such an inductor 210, similarly to the inductor 10 according to the first embodiment, the lower side 52a of the first part can be greatly inclined with respect to the virtual plane A and the gaps D1 and D2 can be efficiently formed. Thus, it is advantageous from the viewpoint of miniaturization.

In addition, the inductor 210 according to the third embodiment also shows the same effects as the inductor 10 in terms of common points with the inductor 10 of the first embodiment.

Although the inductors 10, 110, and 210 according to the invention have been described above with reference to the embodiments, the technical scope of the invention is not limited thereto, and there are many other embodiments and modified examples.

For example, the diameter of the wire 50 and the number of turns of the first part 52 can be appropriately changed according to the properties required for the inductors 10, 110, and 210. Further, the materials and shapes of the electrodes 44 and 47, the core 20, and the plate core 30 can also be different from the shapes shown in the embodiments.

### EXPLANATION OF REFERENCES

10, 110, 210 surface mount inductor
20, 120 core
22 winding core
22a axial direction
22b lower side edge
24, 27, 124, 127 flange
25, 28 outer peripheral surface
25a, 28a lower surface of the flange
25b, 28b upper surface of the flange
25c, 25d side surface of the flange
25e lower outer edge
25f, 125f lower inner edge
26a, 29a end surface
26b, 29b inner side surface of the flange
27 flange
30 plate core
44 electrode
47 electrode
50, 250 wire
52 first part
52a lower side of the first part
52b, 252b upper side of the first part
52c, 252c side of the first part
52d side of the first part
54, 57 second part
54a, 57a contact of the second part
54b, 57b lead-out of the second part
55, 58 wire end
D1, D2 gap
P1 pitch
A virtual plane

What is claimed is:

1. A surface mount inductor comprising:
a core comprising a winding core and a pair of flanges connected to both sides of the winding core;
a pair of electrodes formed on at least a part of the outer peripheral surfaces of the pair of flanges; and
a wire wound around the winding core wherein a pair of wire ends are fixed to the pair of electrodes, wherein
the wire comprises a first part wound in contact with an adjacent turn and a second part wound away from an adjacent turn and is connected to the wire end, and
a gap between the first part and the second part, as viewed from a mounting surface side where the wire end is fixed to the electrode, is 0.5 to 3 times a pitch of the first part.

2. The surface mount inductor according to claim 1 comprising one of the first part and two of the second parts, wherein the first part directly connects two of the second parts.

3. The surface mount inductor according to claim 1, wherein a number of turns of at least one of the second parts is less than one turn.

4. The surface mount inductor according to claim 1, wherein a lower side of the first part, contacting the winding core on the mounting surface side, is wound with respect to a virtual plane orthogonal to an axial direction of the winding core at an inclination of 1.5 to 3 pitches relative to the pitch of the first part.

5. The surface mount inductor according to claim 4, wherein an upper side of the first part, contacting the winding core on a side opposite to the mounting surface side, is wound diagonally with respect to the virtual plane at an inclination smaller than the lower side of the first part.

6. The surface mount inductor according to claim 5, wherein a side of the first part, connecting the upper side of the first part contacting the winding core on the side opposite to the mounting surface side and the lower side of the first part, is wound in parallel to the virtual plane.

7. The surface mount inductor according to claim 4, wherein a side of the first part, connecting the upper side of the first part contacting the winding core on the side opposite to the mounting surface side and the lower side of the first part, is wound with respect to the virtual plane at an inclination smaller than on the lower side of the first part.

8. The surface mount inductor according to claim 1, wherein a contact of the second part, contacting the winding core, is in parallel to a virtual plane orthogonal to an axial direction of the winding core.

9. The surface mount inductor according to claim 1, wherein the second part is distant from a lower edge of the mounting surface side at an edge of the winding core.
